(19) United States
(12) Patent Application Publication
(10) Pub. No.: US 2026/0059418 A1
(43) Pub. Date: Feb. 26, 2026

(54) HANDOVER IN A COMMUNICATION NETWORK

(71) Applicant: Nokia Technologies Oy, Espoo (FI)

(72) Inventors: Panagiotis SPAPIS, Munich (DE); Srinivasan SELVAGANAPATHY, Bangalore (IN); Halit Murat GÜRSU, Munich (DE); Subramanya CHANDRASHEKAR, Bangalore (IN); Umur KARABULUT, Munich (DE); Ahmad AWADA, Munich (DE); Amaanat ALI, Espoo (FI)

(21) Appl. No.: 19/103,657

(22) PCT Filed: Jul. 4, 2023
(86) PCT No.: PCT/EP2023/068417

§ 371 Date: Feb. 13, 2025

(30) Foreign Application Priority Data
Aug. 13, 2022 (IN) 202241046243

(51) Int. Cl. H04W 36/36; H04W 36/00

(52) U.S. Cl. CPC H04W 36/362; H04W 36/0072; H04W 36/0079

(57) ABSTRACT

Inter-alia, methods and apparatuses are disclosed for a handover of a user device in a communication network.

### FIELD

The following disclosure relates to the field of communication technology, in particular wireless communication technology. In particular, the disclosure relates to a handover of a user device in a communication network, in particular a handover of the user device from a source network node to a target network node.

### BACKGROUND

In modern communication networks, a user device is typically connected to the respective communication network via a network node, for instance to a distributed unit (DU). For instance, a base station may host such a DU. The user device may be connected to such a network node such as via a communication link. The communication link may in particular be a radio communication link. The user device may exchange data and/or commands with this network node, in particular via the communication link. As the user device is typically non-stationary and changes its location over time, it may become unfeasible for the user device to continue using the same network node and the same communication link indefinitely. It may instead become necessary for the user device to connect to a new network node. The user device may disconnect from its current (e.g. serving) network node and switch to the new/other network node. This process is referred to as a handover.

### SUMMARY OF SOME EXEMPLARY EMBODIMENTS

A handover of a user device in a communication network is typically done from a first network node, a so-called source node, in particular from a source distributed unit, source DU, to a second network node, a so-called target node, in particular to a target distributed unit, target DU. It has been recognized that such a handover may fail. For instance, the user device may be unable to establish a communication link to the target node.

It has further been recognized that after an unsuccessful handover, the user device may in some cases still have the opportunity to (e.g. re-) establish a communication link to the source node. The user device may thus connect to the communication network via the source node. At least the physical prerequisites for establishing a communication link may still be present. For instance, a signal quality or a signal strength of the source node, in particular as received by the user device, may be sufficient for establishing a communication link between the user device and the network node. As a handover is typically attempted before the connection to the source node is completely lost, a communication link of sufficient quality may be re-established to the source node. The user device may thus revert to the source node in case the handover to a target node was unsuccessful.

Establishing, by the user device, a communication link to the source node after an attempted handover to a target node will be referred to as a so-called fallback, in particular a fallback to the source node.

It has further been recognized that in certain scenarios, the user device may not have access to a radio resource for informing an entity of the communication network about the failed handover to the target node and/or about the fallback to the source node. In particular, the user device may be unable to communicate with the source node after the handover has been initiated. This may for instance be the case if the user device has detached from the source node and/or released a configuration of the source node. A configuration may in this case relate to radio resources reserved for the communication link between the user device and the source node. In this case, a fallback to the source node may be impossible without further preparations such as reserving new radio resources. A recovery procedure may become necessary or alternative measures may be required to re-establish the communication link. Alternatively, the source node may have closed the communication link and may in particular not be awaiting for any data and/or commands potentially transmitted by the user device. For instance, a timer may have run out and the source node may no longer expect messages from the user device. Any messages sent by the user device to the source node may thus be ignored by the source node even if a configuration of the source node, for the user device has not yet been released. In such scenarios, a fallback may be unavailable to the user device. The user device may then be expected to perform a recovery procedure such as in particular a radio resource control, RRC, re-establishment. Such an RRC re-establishment may for instance include a re-selection of a node, decoding of essential system information such as master information block, MIB, and system information block type 1, SIB1, transmission of a request for RRC re-establishment, to the node where the user device will re-establish, fetching of a context for the user device, and reception of a message relating to RRC re-establishment from the network, among others. Such a procedure is lengthy and causes undesirable disconnection times of the user device from the communication network. It moreover consumes battery power.

Such problems may in particular, but not only, arise in so called lower level mobility, LLM, scenarios. Aspects of LLM are directed towards failure handling and source fallback. In LLM, a handover of a respective user device from a source node to a target node may be executed and/or attempted based on at least one measurement in an L1 layer of the communication network. The measurement may be indicative of the connection strength of the communication link between the user device and the current node, i.e. the source node. The measurement may alternatively or additionally be indicative of the signal strength received by the user device from a given network node. The measurement may alternatively or additionally be indicative of the quality of the cell served by the note. Such a measurement may in particular be acquired by the user device and may in particular be transmitted to an entity of the communication network, in particular to the source node. LLM may offer benefits in terms of handover speed and can lead to a reduction in the overall signaling overhead, in particular RCC signaling, in the communication network for a given handover. At the same time, handover failures may occur more frequently compared to other types of handovers, for instance compared to a handover that is based on L3 measurements. This is because measurements in L1 layer are generally relatively unreliable and may depend, for instance, on local blockages, orientations of the user device and/or combinations thereof. For an LLM handover, typically no fallback procedure is defined. This may lead to a need for an expensive and slow re-connection procedure as described above (RRC re-establishment) and ultimately compromises the potential benefits.

It is thus, inter alia, an object to enable a fallback of a user device to a source node in more scenarios and/or enable a re-establishing of a communication quicker than currently possible. One particular application may be a fallback after an attempted handover in a lower level mobility scenario.

According to a first exemplary aspect, a user device is disclosed, the user device comprising: at least one processor; and at least one memory storing instructions that, when executed by the at least one processor, cause the user device at least to perform and/or comprises means for:
obtain, an indication of a fallback message uplink resource;
obtain a handover command for switching from a source distributed unit, source DU, to a target distributed unit, target DU, based on a measurement report or a conditional handover configuration indicative of a condition for performing a handover;
attempt, based on the obtained handover command or the conditional handover configuration, a handover from the source DU to the target DU,; and
in case the handover fails, execute a fallback to the source DU; and
transmit a fallback message using the fallback message uplink resource.

The steps disclosed for the user device may for instance be performed and/or controlled by an apparatus, for instance a server. Alternatively, this method may be performed and/or controlled by more than one apparatus, for instance a server cloud comprising at least two servers. Alternatively, the method may for instance be performed and/or controlled by an electronic device, e.g. a mobile terminal. For instance, the method may be performed and/or controlled by using at least one processor of the electronic device.

According to a further exemplary aspect, a computer program is disclosed, the computer program when executed by a processor causing an apparatus, for instance a server, to perform and/or control the actions as disclosed for the first exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect, an apparatus is disclosed, configured to perform and/or control or comprising respective means for performing and/or controlling the steps disclosed according to the first exemplary aspect.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary aspect, an apparatus is disclosed, comprising at least one processor and at least one memory including computer program code, the at least one memory and the computer program code configured to, with the at least one processor, cause an apparatus, for instance the apparatus, at least to perform and/or to control the steps according to the first exemplary aspect.

The above-disclosed apparatus according to any aspect may be a module or a component for a device, for example a chip. Alternatively, the disclosed apparatus according to any aspect may be a device, for instance a server or server cloud. The disclosed apparatus according to any aspect may comprise only the disclosed components, for instance means, processor, memory, or may further comprise one or more additional components.

The user device according to the first aspect may for instance be a user equipment, UE. The user device may for instance be a mobile device. The user device may in particular be a mobile phone, a tablet, a laptop, a wearable (e.g.,, smart glasses or a smartwatch), an IoT device, an IIoT device, an apparatus such as for example a car or a bike comprising means for connecting to a communication network, and/or combinations thereof.

The user device may for instance be configured to be in communication with a communication network. The user device may for instance establish, maintain and/or release at least one communication link to a communication network. The user device may for instance actively influence at least one communication link to an entity of the communication network and/or the use device may for instance passively undergo changes in its connectivity to the communication network.

The communication network may in particular be a wireless communication network, for example a cellular communication network. For example, the communication network may be a wireless communication network, such as for example a 3G, 4G, 5G and/or 6G communication network as specified by the standards maintained by the 3rd Generation Partnership Project, 3GPP, https://3gpp.org.

The communication network may comprise at least one (e.g. network) node. Such a node of the communication network may for instance be a base station, Base Transceiver Station, BTS, a NodeB, an eNB and/or a gNB. For instance, such a node may be a distributed unit, DU. The user device may be connected to the communication network via a DU. The user device and the DU may be connected to one another by a communication link, in particular are a radio communication link.

In addition to such a node, at least one cell of the communication network may be defined. A cell may for example be defined as a part of a geographical area in which a user device may be located while maintaining a communication link to a node of the communication network. A cell may in this case for example be considered as being served by the node to which the user device may maintain the communication link. A cell may be served by one or multiple nodes.

If here, in the foregoing and/or in the following, disclosure relates to a DU, a node of the communication network in general as well as a cell served by the node is also disclosed in lieu of the DU. In the same way, when a cell is disclosed, this may be understood to comprise a node serving the cell as well, wherein the node may in particular be a DU. If a node is disclosed, this may comprise a DU in specific, as well as a cell served by the node.

The communication network may further comprise at least one central unit, CU. The CU may also be a node of the communication network, for example comprised by a gNB. The CU may for example be in communication with a DU of the communication network. For example, the CU may be in communication with a DU via which the user device is connected to the communication network. The CU and the DU may be in communication through a communication link, for instance a wireless or wired communication link.

In the following disclosure, at least two different distributed units, DUs, will be distinguished. A so-called source DU is a distributed unit to which the user device is connected before a handover. A so-called target DU is a distributed unit to which the user device is supposed to connect after the handover.

The user device comprises at least one processor and at least one memory storing instructions that, when executed by the at least one processor, cause the user device at least to perform steps as disclosed in the following. If here, in the foregoing and/or in the following, an apparatus such as for instance the user device is described as being configured to execute a certain step, this may for example mean that the instructions stored in at least one memory cause the user device to perform the steps, when executed by the at least one processor of the respective apparatus.

The user device is configured to obtain an indication of a fallback message uplink resource.

The indication of a fallback message uplink resource may particular be a message received by the user device, in particular via a communication link. The user device may obtain the indication of a fallback message uplink resource from the communication network. For example, the user device may obtain the indication of a fallback message uplink resource from a node of the communication network, a particular from a DU. For example, the user device may obtain the indication of a fallback method resource from the source DU.

The user device is further configured to obtain a handover command. The handover command may be a handover command for switching, by the user device, from the source DU to a target DU. The handover command may thus be configured to cause the user device to attempt a handover.

A handover between a source DU and a target DU may refer to a handover, in particular of a user device, between a source cell and a target cell. The source cell may be served by the source DU and the target cell may be served by the target DU. As always, instead of a DU, another type of network node of the communication network is disclosed herewith. The handover may optionally comprise the step of connecting, by the user device, to the target DU. Optionally, the user device may become disconnected from the source DU. In the course of a handover, there may be a phase in which the user device is neither connected to the source DU nor to the target DU. For instance, the user device may be unable to maintain two or more communication links to two or more different DUs at the same time. A user device may alternatively be configured to maintain at least one communication link to at least one DU throughout the handover.

The obtaining (e.g. receiving) of a handover command may be based on a measurement report.

For instance, the measurement report may be an L1 measurement report. The measurement report may be indicative of a signal quality and/or signal strength of a DU, in particular of the source DU. In particular, this may be a signal strength and/or signal quality as received (e.g., measured) by the user device. The measurement report may for instance be acquired by the user device, e.g. acquired at least partially by means of a physical measurement of the user device, for instance by at least one antenna of the user device. The user device may in this case for instance measure the physical field strength as received by an antenna of the user device. Acquiring the measurement report may for instance alternatively or additionally be at least partially based on receiving a message and/or no not receiving a message, in particular from the DU. Acquiring the measurement report may for instance alternatively or additionally involve evaluating how many of transmission errors occur when communication with the DU. The measurement report may depend on a position of the user device, in particular with relation to the source DU, on an orientation of the user device or on the presence, proximity and/or position of obstacles and/or combinations thereof.

If here, in the foregoing or the following, an antenna is disclosed, this relates to a device for physically receiving electromagnetic waves, in particular through an air interface. An antenna may for instance comprise an electrical conductor. Other words that may be used interchangeably for an antenna are for instance an aerial and a panel.

Alternatively or additionally to the handover command, the user device may obtain (e.g. receive) a conditional handover configuration. The conditional handover configuration may be indicative of a condition for performing a/the handover. For instance, the conditional handover configuration may indicate a condition based on a time, for instance a timer of a predefined duration, a condition based on a measurement, in particular a measurement acquired by the user device, and/or a condition based on a further indication of a handover. The conditional handover configuration may be configured to cause the user device to attempt a handover in case the condition for attempting and/or performing a handover is fulfilled. Additionally or alternatively, the user device may be configured to attempt and/or perform a handover if the handover condition is fulfilled.

The handover command and/or the conditional handover configuration may be obtained from the source DU. The handover condition may be set by the source DU.

The indication of a fallback message uplink resource may be obtained together with the handover command or, in case of a conditional handover configuration instead of a handover command, together with the conditional handover configuration.

The user device is further configured to attempt a handover from the source DU to the target DU. The user device may attempt the handover based on the obtained handover command. In particular, the handover command and/or the user device may be configured in a way that the user device attempts a handover essentially immediately after obtaining the handover command. For instance, the time between the obtaining of the handover command and the attempting of a handover may be less than 1 μs, 5 μs, 100 μs, 500 μs, 1 ms, 5 ms, 10 ms, 50 ms, 100 ms, 500 ms or 1 s, preferably less than 50 ms. Additionally or alternatively to the handover command, the user device may attempt a handover based on the conditional handover configuration. For example, a condition indicated by the conditional handover configuration may be fulfilled. This fulfillment of the condition may cause the user device to attempt the handover. The user device may evaluate the condition indicated by the conditional handover configuration. For instance, the user device may measure at least one measurement, for instance and L1 measurement, for instance relating to the source DU. If the measurement fulfills a condition indicated by the conditional handover configuration, the user device may attempt the handover. There does not need to be a close temporal correlation between the user device obtaining the conditional handover command and attempting a handover. For instance, after obtaining the conditional handover configuration, a time of up to 0.5 s, 1 s, 2 s, 3 s, 5 s of 10 s may elapse before the user device attempts a handover.

The handover from the source DU to the target DU may fail, e.g. for one or more of the following reasons. For instance, the user device may fail in connecting to the target DU. For example, after a failed connection attempt to the target DU, the user device may not be connected to either of the source DU or the target DU.

The user device may be configured to execute a fallback to the source DU in case the handover fails. The fallback to the source DU may for instance at least partially be based on the indication of the fallback message uplink resource. Alternatively, the fallback to the source DU may at least partially or be (e.g. fully) independent of the fallback message uplink resource. For example, the user device may use a previously provided source configuration, in particular a radio resource control, RRC, configuration, for the fallback. The previously provided source configuration may in particular be a RRC configuration of the source DU. After the fallback, the user device may be re-configured by the network to a different RRC configuration. Until such re-configuration, the previously provided RRC configuration may be used by the user device to establish and/or maintain a connection to the source DU.

The user device may be configured to not execute a fallback in case the handover does not fail, i.e. if the handover succeeds.

The user device is further configured to transmit a fallback message. The fallback message is transmitted by the user device using the fallback message uplink resource. By obtaining (e.g. receiving) an/the indication of a fallback message uplink resource, the user device is thus enabled to communicate, to the communication network, a failed handover to the target DU and/or the fallback to the source DU. The user device may thus be independent from the availability of other uplink resources that may or may not be used for the transmission of such a fallback message. Instead, a dedicated resource, the fallback message uplink resource, is reserved for the specific purpose of communicating the fallback. In this way it may be enabled (e.g. guaranteed) that the fallback message can be transmitted by the user device (e.g. to the source node). After the transmission of the fallback message, a re-configuration to a new source configuration with different resources compared to the previously provided source configuration may be done, in particular at least partially based and/or caused by the fallback message. The user device may even be able to execute a fallback to the source DU after detaching from it, e.g., after the source configuration has been released. By informing the source DU and/or the communication network about a failed handover to the target DU, a new source configuration may be assigned to the user device for executing the fallback.

The user device may in particular be configured to transmit the fallback message in case the handover fails. If, however, the handover succeeds, the fallback message may be not transmitted.

The fallback message may comprise and/or be accompanied by a failure report. Additionally or alternatively, the fallback message may be comprised by a failure report. The fallback message and/or the failure report may be transmitted to the source DU. The failure report may comprise information about the way in which the attempted handover failed (e.g., failure cause and/or timing information).

The user device may be configured to perform and/or control (e.g. carry out) one or more of the steps disclosed above e.g. in the order in which they are disclosed. The steps may also be permuted where applicable. For instance, the user device may transmit the fallback message before executing the fallback or the user device may execute the fallback before transmitting the fallback message. Consecutive steps may be carried out at the same time where applicable.

According to an embodiment of the first exemplary aspect,
the handover fails because the user device fails to apply a new configuration to the target DU and/or
the handover fails because the user device fails to execute a random access to the target DU, in particular a random access channel, RACH, access of the user device fails.

According to an embodiment of the first exemplary aspect,
the fallback message uplink resource is pre-configured and the indication of the fallback message uplink resource is obtained
   via radio resource control, RRC, re-configuration and/or
   as a part of the handover command and/or the conditional handover configuration.

The fallback message uplink resource may be pre-configured. In this case, for example, the indication of the fallback message uplink resource may be obtained via radio resource control, RRC, re-configuration. The user device may receive the RRC-re-configuration. The RRC re-configuration may for example relate to a lower level mobility of the user device. In this case, the RRC re-configuration may configure the lower level mobility of the user device.

Alternatively or additionally, the indication of the fallback message uplink resource is obtained as part of the handover command. For instance, the handover command may take the form of a medium access control, MAC, command. In this case, the indication of the fallback message uplink resource may be provided in the same message carrying the MAC command. Additionally or alternatively the indication of the fallback message uplink resource may be obtained in a separate message, for instance in a MAC control element, MAC CE.

For example, the fallback message uplink resource may be obtained as part of the conditional handover configuration.

If the fallback message uplink resource is pre-configured, it may be, for instance, an uplink grant. Additionally or alternatively, the pre-configured fallback message uplink resource may be a scheduling grant for an aperiodic L1-report, in particular triggered by downlink control information, DCI.

The fallback message uplink resource can for instance be linked to a reception timing of physical downlink shared channel, PDSCH, containing the handover command.

Features of this embodiment may in particular apply when the user device fails to apply a new configuration, in particular a new RRC configuration for the target DU, as part of the handover.

According to an embodiment of the first exemplary aspect,
the fallback message uplink resource is a next uplink resource available, wherein the next uplink resource available is configured as a periodic uplink resource allocation.

The user device may transmit a fallback message on a next uplink resource available. In this case, the fallback message uplink resource may be configured as a periodic uplink resource allocation. In this case, the source DU may internally activate an uplink reception based on a time value. In particular, such activation of uplink reception may be based on a timer value. The timer value may be configured within the periodic uplink resources configured for the fallback. The timer may be associated with an access failure within the periodic uplink resources configured for the fallback.

An indication of the periodic uplink resource may be obtained (e.g. received) by the user device by RRC re-configuration, wherein the RRC re-configuration in particular configures a lower level mobility of the user device.

For example, the user device may execute a fallback procedure on the next uplink resource available which is configured as periodic uplink resource allocation. The source DU may internally activate an uplink reception based on a timer value. The timer value may in particular be associated with an access failure within the periodic uplink resources configured for the fallback message. The periodic uplink resource may for instance be provisioned as part of an RRC re-configuration, in particular by an RRC re-configuration configuring an LLM and/or the handover.

Features of this embodiment may in particular apply when the user device fails in target DU access, as part of the handover. For instance, the user device may fail to execute a random access channel, RACH, access to the target DU.

Reverting to the source DU may be made conditional upon a fallback condition. For example, a communication link quality between the user a device and the source DU may be required to be above a predefined threshold.

According to an embodiment of the first exemplary aspect, the instructions, when executed by the at least one processor, may further cause the user device to perform:
inform a central unit, CU, about the fallback of the user device to the source DU.

The central unit, CU, may particular be a CU which at least partially controls the source DU. The user device may particular inform the CU via the source DU using the fallback message. In other words, the user device may transmit at least part of the fallback message and/or an indication of a fallback least partially based on the fallback message via the source DU, to the CU. This may for instance comprise the user device at least partially instructing and/or controlling the source DU, in particular by means of the fallback message and/or other signaling such as a failure report, to the extent that the source DU informs the CU about the fallback. The source DU may for instance be configured to inform the CU about the fallback of the user device when it receives the fallback message from the user device.

By informing the CU about the fallback of the user device to the source DU, the CU may prevent a release of a source configuration of the user device for the source DU. Additionally or alternatively, the CU may trigger a context release of the user device from the target DU. The user device may thus stay connected to the communication network via the source DU without service interruption.

According to an embodiment of the first exemplary aspect, the instructions, when executed by the at least one processor, may further cause the user device to perform:
obtain (e.g. receive) an indication of a fallback condition, wherein the fallback condition needs to be fulfilled for executing the fallback of the user device to the source DU.

The fallback condition may be used for a/the decision whether the user device should perform a fallback to the source DU or not. The fallback condition may for instance additionally or alternatively be used for the decision whether other recovery procedures such as for example an RRC reestablishment should be performed. For example, if the fallback condition is fulfilled, the user device executes a fallback and if the fallback condition is not fulfilled, the user device executes a recovery procedure such as for instance an RRC reestablishment. In other words, the user device may be configured to not execute a fallback unless the fallback condition is fulfilled. In particular, if the fallback condition is fulfilled, the user device may execute the fallback, whereas, if the fallback condition is not fulfilled, a recovery procedure is executed.

The indication of a fallback condition may for instance be obtained (e.g. received) as part of and/or accompanied by the handover command and/or the conditional handover configuration.

Additionally or alternatively, the indication of the fallback condition may be obtained during a context set up procedure of the user device.

Additionally or alternatively, the indication of a fallback condition may be obtained as part of and/or accompanied by the indication of the fallback message uplink resource. For instance, the indication of the fallback condition may sent together with the indication of the fallback message uplink resource in an RRC re-configuration message. When obtaining the fallback condition together and/or in short succession with the fallback message uplink resource, the user device is already aware of the fallback condition before the handover command and/or the conditional handover configuration is received. The user device is in this case already informed about the fallback condition prior to attempting a handover. It may for instance evaluate the fallback condition prior to attempting the handover.

The indication of a fallback condition may for instance be obtained by means of RRC, in particular RRC re-configuration. In this case, the fallback condition may be obtained prior to obtaining a handover command and/or a conditional handover configuration. Additionally or alternatively, the indication of a fallback condition may for instance be obtained by means of MAC, in particular together with a handover command and/or a conditional handover configuration obtained by MAC and/or by a separate MAC control element, MAC CE.

The fallback condition indicated by the indication of the fallback condition may for instance be evaluated by the user device. For instance, the user device may evaluate whether the fallback condition is fulfilled after the handover has failed. Additionally or alternatively, the user device may evaluate the fallback condition already before and/or when attempting the handover.

According to an embodiment of the first exemplary aspect,
the indication of the fallback condition is obtained together with the indication of the fallback message uplink resource; and/or
the fallback condition is set by the CU; and/or
the fallback condition is at least partly based on a target DU measurement.

The indication of the fallback condition may be obtained together with the indication of the fallback message uplink resource.

Additionally or alternatively, the indication of the fallback condition may be obtained together with the handover command and/or with the conditional handover configuration.

If here, in the foregoing and/or in the following, two elements (e.g., pieces of information, messages, etc.) are disclosed as being obtained or transmitted together, this may particular mean that they are obtained or transmitted essentially at the same time. For instance, the interval between receiving a first of the two elements and a second of the two elements may be less than 1 μs, 5 μs, 100 μs, 500 μs, 1 ms, 5 ms, 10 ms, 50 ms, 100 ms, 500 ms or 1 s. If the two elements are obtained or transmitted together this may alternatively or additionally mean that both elements are obtained or transmitted in the same message. Alternatively or additionally, the two elements may be identified by a same identification information such as for instance a same identification number, e.g. a cell ID, a measurement ID and/or combinations thereof. For instance they may be obtained or transmitted in the same RRC re-configuration message and/or in the same MAC message. The two elements may for instance be the indication of the fallback condition on the one hand and the indication of the fallback message uplink resource on the other hand. The two elements may for instance be the indication of the fallback condition on the one hand and the handover command and/or the conditional handover configuration on the other hand.

For example, the CU may define the fallback condition, which is in particular used for the decision on whether the user device should execute a fallback to the source DU or not. The fallback condition may additionally or alternatively be used to decide one or more other recovery procedures different from the fallback. Such other recovery procedures may for instance comprise a re-establishment, in particular an RRC reestablishment. Tentatively or additionally, the fallback condition may be provided by the source DU, for instance during a user device context set up procedure. Additionally or alternatively, the CU may obtain at least one measurement relating to the target DU and/or the target cell served by the target DU from the source DU. The CU may for instance request such measurements from the source DU. The source DU may provide the fallback condition respectively. Such a procedure based on measurements relating to the target DU may for instance be implemented using a user device context modification request and response.

According to an embodiment of the first exemplary aspect, the fallback condition comprises
a minimum signal strength and/or signal quality of the source DU; and/or
a comparison of the signal strength and/or signal quality of the source DU to one or more potential target DUs; and/or
a comparison of the signal strength and/or signal quality of the source DU to neighboring DUs.

The fallback condition may comprise a minimum signal strength and/or signal quality of the source DU, for instance in a given time period. An actual signal strength of the source DU may be compared to the minimum signal strength and/or signal quality of the source DU, which is comprised by the fallback condition. Based on this comparison, the user device may connect to (i.e., fall back to) the source DU or not connect to the source DU. The comparison may be carried out for a pre-defined time period. For example, a timer may limit the duration during which the fallback condition is evaluated. For example, if the actual signal strength and/or signal quality is below the minimum signal strength and/or signal quality for a pre-defined time period, the condition is evaluated as not fulfilled. Additionally or alternatively, the condition may be evaluated as fulfilled if the signal strength and/or signal quality is higher than or equal to the minimum signal strength and/or signal quality for a pre-defined time period. Alternatively, a single value of the actual signal strength and/or signal quality may be compared to the minimum signal strength and/or signal quality in order to evaluate the fallback condition. In particular, the user device may (e.g. only) connect to the source DU, if the actual signal strength and/or signal quality is above the minimum signal strength and/or signal quality, respectively, for instance for a pre-defined time period. The minimum signal strength and/or signal quality can thus be seen as a threshold, above which a signal quality and/or signal strength is strong enough for a fallback but below which the quality and/or strength is too low for a fallback. The actual signal strength may for instance be measured by the user device, for instance by at least one antenna (e.g., panel) of the user device.

The fallback condition may alternatively or additionally comprise a comparison of the signal strength and/or signal quality of the source DU to one or more potential target DUs. A potential target DU may be a DU that the user device may connect to after a failed handover to the target DU. In particular, the fallback condition may specify that the signal strength and/or signal quality of the source DU is the strongest signal strength and/or signal quality compared to all potential target DUs, in particular on at least one antenna (e.g., panel) of the user device.

The fallback condition may alternatively or additionally comprise a comparison of the signal strength and/or signal quality of the source DU to at least one neighboring DU. The at least one neighboring DU may for instance be a given number of DUs, which are spatially closest to the source DU and/or to the user device. The source DU is not part of the neighboring DUs. For instance, the neighboring DUs may comprise the 1, 2, 3, 4, 5, 6, 7, 8, 9, 10, 11, 12, 13, 14, 15, 16, 17, 18, 19 or 20 or more closest DUs. Additionally or alternatively, the neighboring DUs may be DUs of which the signal strength and/or signal quality, in particular as received by the user device, is above a given threshold. The fallback condition may for example specify that the source DU has to have a higher signal strength and/or signal quality than all neighboring DUs.

A fallback condition that relates to signal strength and/or signal quality, the strength and/or quality of the signal may be determined by the user device. The user device may measure the signal strength and/or signal quality. The user device may for instance receive at least one radio signal from the source DU and estimate the signal strength and/or signal quality of the source DU based on this received radio signal. This user device may receive the at least one radio signal using at least one antenna. The antenna is in particular part of the user device.

For example, the fallback condition may be defined as one of the following. The signal strength and/or signal quality of the source DU and/or source cell needs to be higher than a predefined threshold. The threshold may be predefined in such a way that the signal strength and/or signal quality is sufficient for the source DU to be selected for re-establishing a communication link with the source node. In this case, a fallback to the source DU may be possible. This fallback condition corresponds to the minimum signal strength and/or signal quality disclosed above. Alternatively or additionally, the fallback condition may specify that the source cell needs to be the strongest cell according to a measurement on at least one or two are more of the antennae (e.g., panels), in particular of the user device. Additionally or alternatively, the fallback condition may specify that there is no neighboring cell measurement is stronger than a measurement of the source cell. In particular, a predefined offset between the measurement (e.g., signal strength and/or signal quality) of the source cell and the respective measurement of any neighboring cell may be specified by the fallback condition. For instance, (e.g. only) if the source cell provides a stronger measurement by the predefined offset compared to the neighboring cells, it may be selected for a fallback.

A measurement acquired by the user device may for example be acquired by any antenna of the user device, a given subset of antennae and/or all antennae. If the condition is evaluated on multiple antennae, it may need to be fulfilled on all antennae, on at least one antenna and/or on the majority of the considered antennae. A timer may be used to restrict the process of comparing measurements among each other or of a given measurement to a predefined threshold etc.

According to a second exemplary aspect, a source distributed unit, source DU, is disclosed, comprising at least one processor; and at least one memory storing instructions that, when executed by the at least one processor, cause the source DU at least to perform and/or comprises means for:
transmit an indication of a fallback message uplink resource,
transmit a handover command for switching from the source DU to a target distributed unit, target DU, based on a measurement report or a conditional handover configuration indicative of a condition for performing a handover; and
obtain a fallback message, using the fallback message uplink resource.

According to a further exemplary aspect, a computer program is disclosed, the computer program when executed by a processor causing an apparatus, for instance a server, to perform and/or control the actions as disclosed for the second exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect, an apparatus is disclosed, configured to perform and/or control or comprising respective means for performing and/or controlling the steps disclosed according to the second exemplary aspect.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary aspect, an apparatus is disclosed, comprising at least one processor and at least one memory including computer program code, the at least one memory and the computer program code configured to, with the at least one processor, cause an apparatus, for instance the apparatus, at least to perform and/or to control the steps according to the second exemplary aspect.

The above-disclosed apparatus according to any aspect may be a module or a component for a device, for example a chip. Alternatively, the disclosed apparatus according to any aspect may be a device, for instance a server or server cloud. The disclosed apparatus according to any aspect may comprise only the disclosed components, for instance means, processor, memory, or may further comprise one or more additional components.

The source DU may for instance be a node of a communication network. The source DU may be or be comprised by (e.g. hosted by) a gNB in a (e.g. 5G) communication network, for example.

The source DU transmits an indication of a fallback message uplink resource. For example, the source DU transmits the indication of a fallback message uplink resource to a user device. The user device may be connected to the source DU. For example, the user device may be attached to the source DU. For instance, the user device may be attached to the source DU using a source configuration. For example, the user device may have been previously configured by RRC for being connected to the source DU.

According to an embodiment of the second exemplary aspect, the source DU may for example transmit an indication of a fallback message uplink resource in reaction to obtaining a fallback configuration. The fallback configuration may be obtained from a central unit, CU. If the source DU transmits the indication in reaction to obtaining the configuration, this may mean that the source DU does not transmit the indication of a fallback message uplink resource unless it obtains the fallback configuration. The source DU may particular essentially immediately transmit the indication of a fallback message uplink resource after obtaining the fallback configuration.

The source DU may transmit a handover command. For example, the source DU may transmit the handover command based on a measurement report, in particular based on an L1 measurement report.

Additionally or alternatively, the source DU may transmit a conditional handover configuration. The conditional handover configuration is indicative of a condition for performing a handover. The handover command and/or the conditional handover configuration may be transmitted by the source DU to a user device, in particular to the user device to which the source DU transmitted the indication of a fallback message uplink resource.

The source DU may obtain a fallback message. For example, the source DU may obtain a fallback message using the fallback message uplink resource. For example, the source DU may obtain the fallback message from a user device, in particular from the user device, to which the source DU has transmitted the indication of a fallback message uplink resource and a handover command or a conditional handover configuration.

According to an embodiment of the second exemplary aspect, the instructions, when executed by the at least one processor, may further cause the source DU to perform:
obtain, from a central unit, CU, the indication of the fallback message uplink resource and/or
obtain, from a central unit, CU, an indication of a fallback configuration of the user device.

The source DU may obtain the indication of the fallback message uplink resource. In particular, the source DU may obtain the indication of the fallback message uplink resource from a central unit, CU. This CU may particular at least partially control the source DU.

Additionally or alternatively, the source DU may obtain, from a central unit, CU, an indication of a fallback configuration of the user device. The indication of a fallback configuration may inform the source DU about the user device being configured to execute a fallback to the source DU, in particular in case an attempted handover of the source DU to another DU, in particular to a target DU, fails.

According to an embodiment of the second exemplary aspect, the instructions, when executed by the at least one processor, may further cause the source DU to perform:
obtain, from the CU an indication of a fallback condition.

According to an embodiment of the second exemplary aspect, the instructions, when executed by the at least one processor, may further cause the source DU to perform: transmit an indication of a fallback condition.

The source DU may transmit the indication of a fallback condition to the user device. For example, the source DU may transmit the indication of a fallback condition together with the indication of a fallback message uplink resource, in particular to the user device. Additionally or alternatively, the source DU may transmit the indication of a fallback condition together with the handover command and/or the conditional handover configuration.

The fallback condition may be set (e.g. determined) by the source DU. For example, the fallback condition may be set by the source DU if the source DU transmits a conditional handover configuration to the user device and no handover command.

Additionally or alternatively, the fallback condition may be obtained by the source DU, in particular from a CU. In this case, the source DU may not influence the fallback condition. Instead, it may forward the fallback condition without amendment. The CU may in this case in particular at least partially control the source DU. For example, if the source DU transmits a handover command to the user device, the fallback condition may be obtained by the source DU. In this case, the source DU may for example not transmit a conditional handover configuration to the user device.

According to an embodiment of the second exemplary aspect, the instructions, when executed by the at least one processor, may further cause the source DU to perform:
prevent a release of a source configuration of the user device after transmitting the handover command and/or the conditional handover configuration to the user device.

A source configuration may here and in the following and/or foregoing relate to and/or indicate a set of radio resources that may be used by the source DU to communicate with the user device and/or vice versa. The source configuration may be associated with and/or be reserved for a user device until the user device is detached and/or detaches from the source DU. For example, the set of radio resources to which the source configuration relates and/or which it indicates, may be reserved for the user device at least for as long as it is connected to the source DU, i.e. until the user device is detached. A release of the source configuration of the user device may particular mean that the radio resources are then free to be assigned to a different purpose, for instance to a different user device. The user device may therefore no longer use the radio resources the source configuration indicates and/or relates to, e.g. once the source configuration has been released. By preventing a release of the source configuration, the source DU may enable the user device to continue using the configuration, e.g., the radio resources. By preventing such a release even after transmitting the handover command and/or the conditional handover configuration, the source DU may enable the user device to fall back to the source DU after a failed handover using the same source configuration that it used before the attempted handover. The source configuration may be re-used by the user device when it is not released.

For example, the source DU may prevent the release of the source configuration for a pre-defined time. For instance, the source DU may start a timer of a pre-defined duration after transmitting the handover command and/or the conditional handover configuration to the user device and/or after being informed about an attempted handover and/or after the user device closes a communication link to the source DU. The duration of the timer may for instance be less than 1 ms, 5 ms, 10 ms, 50 ms, 200 ms. 1 s, 10 s, 1 min, 2 min, 5 min or 10 min.

According to an embodiment of the second exemplary aspect, the instructions, when executed by the at least one processor, may further cause the source DU to perform:
determine the fallback message uplink resources before transmitting the indication of the fallback message uplink resources.

Further details of the second exemplary aspect are disclosed in the description of the other exemplary aspects. Disclosure relating to these other exemplary aspects is disclosed for the second exemplary aspect as well, where applicable.

According to a third exemplary aspect, a central unit, CU, is disclosed, comprising at least one processor; and at least one memory storing instructions that, when executed by the at least one processor, cause the CU at least to perform and/or comprises means for:
transmit, to a target distributed unit, target DU, an indication of a fallback option of a user device; and
transmit, to a source distributed unit, source DU, an indication of a fallback configuration of the user device.

According to a further exemplary aspect, a computer program is disclosed, the computer program when executed by a processor causing an apparatus, for instance a server, to perform and/or control the actions as disclosed for the third exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect, an apparatus is disclosed, configured to perform and/or control or comprising respective means for performing and/or controlling the steps disclosed according to the third exemplary aspect.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary aspect, an apparatus is disclosed, comprising at least one processor and at least one memory including computer program code, the at least one memory and the computer program code configured to, with the at least one processor, cause an apparatus, for instance the apparatus, at least to perform and/or to control the steps according to the third exemplary aspect.

The above-disclosed apparatus according to any aspect may be a module or a component for a device, for example a chip. Alternatively, the disclosed apparatus according to any aspect may be a device, for instance a server or server cloud. The disclosed apparatus according to any aspect may comprise only the disclosed components, for instance means, processor, memory, or may further comprise one or more additional components.

The CU may transmit, to a target distributed unit, an indication of a fallback option. The indication of a fallback option may indicate, to the target DU, that the user device may execute a fallback in case an attempted handover to the target DU fails. The CU may for instance transmit the indication of a fallback option together with a context setup request. The context setup request may for example comprise indication of a target configuration. The target configuration may specify radio resources to be used by the user device once connected to the target DU, i.e. after a successful handover.

The CU may transmit an indication of a timer to the target DU. For instance such indication can be transmitted together with the indication of a fallback option of a user device. The timer may enable the target DU to perform at least one step associated with the fallback if the user device fails at executing the handover. The timer may allow enough time to be sure that if a handover had been successful, the user device would already be connected to the target DU. For instance, after expiration of the timer, the target DU may automatically release a target configuration of the user device.

The target distributed unit, target DU, may be a DU to which a user device is supposed to attempt a handover, in particular from a source distributed unit, source DU. The CU may at least partially control the targeted DU. The CU may select a target DU for the user device.

The source distributed unit, source DU, may be a DU to which a user device is currently connected and/or attached. In particular, the source DU may be a DU, from which the user device is supposed to attempt a handover. The CU may at least partially control the source DU.

According to an embodiment of the third exemplary aspect,
the indication of a fallback option is accompanied by an indication of a fallback condition.

The specifics of the fallback condition are disclosed above with respect to the first and/or second exemplary aspect.

According to an embodiment of the third exemplary aspect, the instructions, when executed by the at least one processor, may further cause the CU to perform:
set the fallback configuration based, at least in part, on at least one measurement relating to the target DU.

The measurement may particular be a measurement relating to the L1 layer of the communication network. The CU may in particular obtain the measurement from the source DU. The measurement may have been measured by the user device. In this case, the CU may obtain the measurement from the user device via the source DU. The measurement may be an L3 measurement.

According to an embodiment of the third exemplary aspect, the instructions, when executed by the at least one processor, may further cause the CU to perform:
obtain an indication of a performed fallback of the user device to the source DU at least partially based on a fallback message uplink resource; and
transmit a context release request for the user device to the target DU upon the obtaining.

The CU may obtain an indication of a performed fallback of the user device to the source DU. The CU may obtain the indication of the performed fallback from the source DU, for example. The CU may obtain the indication at least partially based on a fallback message uplink resource. In particular, the user device may have transmitted a fallback message to the source DU using the fallback message uplink resource. The source DU may transmit an indication of the performed fallback to the CU, in particular based on the fallback message it obtained from the user device using the fallback message uplink resource. The CU may thus obtain an indication of a performed fallback from the user device via the source DU at least partially based on the fallback message uplink resource.

The CU may additionally or alternatively transmit a context release request to the target DU. The CU may in particular transmit the context release request to the target DU after the CU obtains the indication of the performed fallback the user device to the source DU. The context release request may indicate to the target DU, that a target configuration of the user device may be released. The target configuration may specify radio resources that the user device may have used once connecting to the target DU.

According to a further exemplary aspect, a system is disclosed, comprising at least two of a user device according to the first exemplary aspect, a source DU according to the second exemplary aspect or a CU according to the third exemplary aspect as disclosed above.

According to an example embodiment of all exemplary aspects, in case the handover of the user device to the target DU is successful, the executing of the fallback and/or the transmitting and/or obtaining of the fallback message is not performed and/or controlled.

The features and example embodiments described above for at least one of the different aspects (in particular, the first, the second and the third exemplary aspect), may equally respectively pertain to all aspects.

It is to be understood that the presentation in this section is merely by way of examples and non-limiting.

Other features will become apparent from the following detailed description considered in conjunction with the accompanying drawings. It is to be understood, however, that the drawings are designed solely for purposes of illustration and not as a definition of the limits, for which reference should be made to the appended claims. It should be further understood that the drawings are not drawn to scale and that they are merely intended to conceptually illustrate the structures and procedures described herein.

### LIST OF ABBREVIATIONS

CBRA Contention Free Random Access
CFRA Contention Based Random Access
CHO Conditional Handover
CU Central Unit
DAPS Dual Active Protocol Stack
DU Distributed Unit
HO Handover
LLM Low Layer Mobility
MAC CE Medium Access Control Control Element
RACH Random Access Channel
RRC Radio Resource Control
TA Timing Advance
UE User Equipment

### BRIEF DESCRIPTION OF THE DRAWINGS

In the figures show:

FIG. 1 a schematic diagram of a communication network as used by example embodiments of all exemplary aspects;

FIGS. 2a-d schematic diagrams of measurements of a user device as used by example embodiments of all exemplary aspects;

FIG. 3 a flowchart showing a method according to the first exemplary aspect;

FIG. 4 a flowchart showing a method according to the second exemplary aspect;

FIG. 5 a flowchart showing a method according to the third exemplary aspect;

FIG. 6 a signaling diagram showing a method according all of the exemplary aspects;

FIG. 7 a signaling diagram showing a method according all of the exemplary aspects;

FIG. 8 a schematic diagram of an apparatus (e.g. user device) according to the first exemplary aspect;

FIG. 9 a schematic diagram of an apparatus (e.g. source DU) according to the second exemplary aspect;

FIG. 10 a schematic diagram of an apparatus (e.g. CU) according to the third exemplary aspect;

FIG. 11 examples of storage media.

### DETAILED DESCRIPTION OF SOME EXEMPLARY EMBODIMENTS

The following description serves to deepen the understanding and shall be understood to complement and be read together with the description as provided in the above summary section of this specification.

Embodiments shown in at least one of the figures and their description may be combined with any of the exemplary aspects and their exemplary embodiments described above.

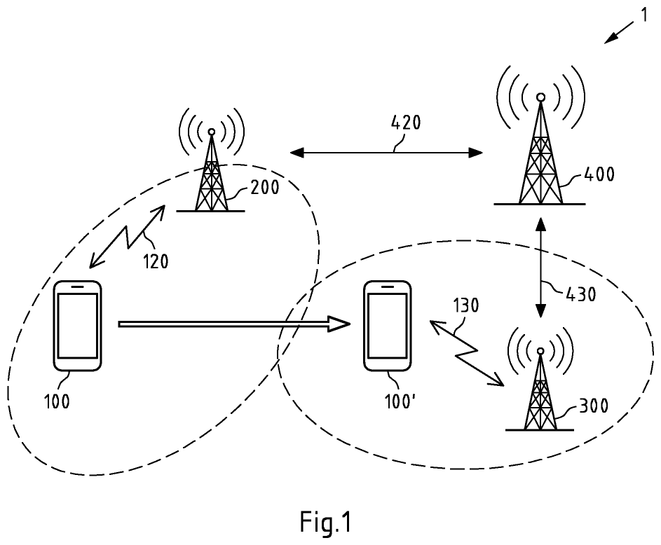

FIG. 1 shows a schematic diagram of a communication network 1. The communication network 1 is a wireless communication network. Shown are a first distributed unit, DU, 200 and a second distributed unit, DU, 300. Both the first DU 100 and the second DU 300 provide network services in a respective cell. The cell may be a geographical area which in the diagram in FIG. 1 is indicated by a dashed outline. A user device 100 is connected to the first DU 200 via a communication link 120. This is in particular possible because the user device 100 is located within the cell served by the DU 200.

The communication network 1 may further comprise a central unit, CU, 400. The CU 400 connected to the source DU 200 via a communication link 420. The CU 400 may be connected to the target DU via a communication link 430. If the CU 400 may control at least partially at least one of the source DU 200 and/or the target DU 300.

FIG. 1 shows a handover scenario of the user device 100 from the first the DU 200 to the second DU 300. The first DU 200 may be considered a source DU 200. When the user device 100 moves within the communication network 1, it may enlarge the distance to the source DU 200. In FIG. 1, the movement of the user device 100 is indicated by an arrow and a first position of the user device 100 is indicated by the reference numeral 100, whereas the second position is indicated by a reference numeral 100′. Ultimately, the user device 100,100′ may leave the cell of the source DU 200 and may thus no longer be connected to the source DU 200 via a communication link 120.

At a new position of the user device 100′, the user device may be close enough to the target DU 300 in order to be connected to it via a communication link 130. To change the DU to which the user device 100 is connected, a handover of the user device 100 from the source DU 200 to the target DU 300 is necessary. The handover may for instance be attempted by the user device 100 based on a reduced and/or low and/or insufficient signal strength and/or signal quality of the source DU 200. The user device 100 may in particular be able to sense the necessity and/or possibility of a handover from the source DU 200 to the target DU 300. For instance, the user device 100 may acquire at least one measurement from the source DU 200 and/or the target DU 300. In particular, the user device 100 may acquire a measurement of a signal strength and/or signal quality from the source DU 200 and/or the target DU 300. The measurement may in particular be an L1 measurement. For instance, the user device 100 and/or the source DU 200 may at least partially base the decision on whether a handover is attempted or not, on such a measurement acquired by the user device 100.

Example embodiments of all exemplary aspect may thus allow a fast handover based on measurements acquired by the user device 100. When the user device 100 detects a signal quality and/or signal strength which is insufficient, an essentially immediate change of the serving DU (from source DU 200 to target DU 300) may be attempted. The duration for which a user device may be stuck with a bad signal strength and/or signal quality may thus be reduced. At the same time, the fallback message uplink resource may allow a fast and seamless fallback of the user device 100 to the source DU 200 in case the handover to the target DU 300 does not succeed. In this way, service interruptions may be minimized and communication overhead may be reduced.

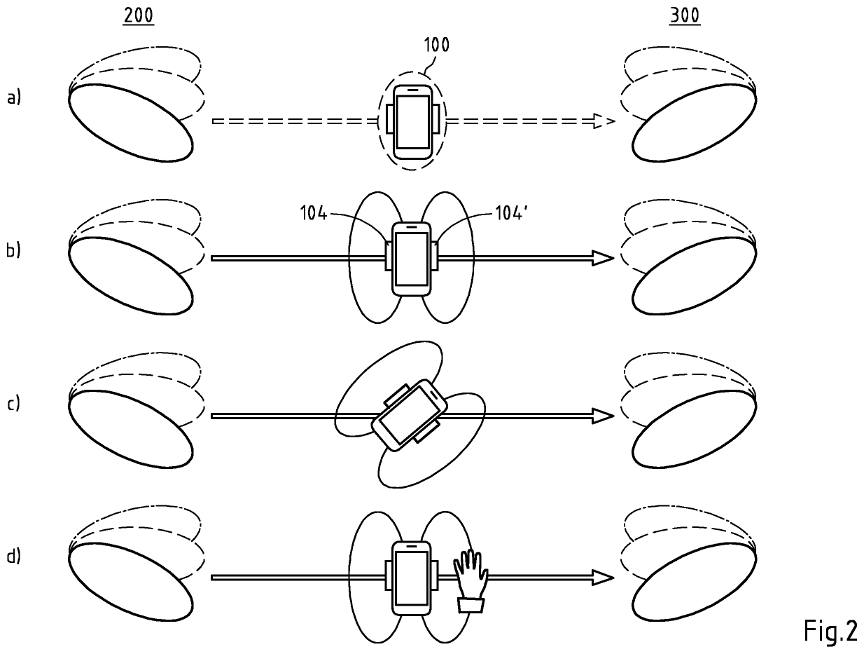

FIG. 2 shows schematic examples of measurements of a user device 100. The user device 100 may comprise at least one or two or more antennae 104, 104′. An antenna 104, 104 may have a reception characteristic, which may be anisotropic. I.e., the reception sensitivity is dependent on the orientation of the antenna with respect to an origin of a sensed signal. FIG. 2 also shows a source DU 200, in particular a cell 200 served by the source DU 200. Also, FIG. 2 shows a target DU 300, in particular a cell served by the target DU 300.

If the user device 100 measures a signal strength and/or signal quality, for instance of the source cell 200 and/or the target cell 300, such a measurement will depend on the orientation of the user device 100, among other things. FIG. 2 in particular shows a user device 100 which acquires L1 measurements. The L1 measurements for example relate to the momentarily physically obtainable (e.g. observable) signal strength at a given antennae 104, 104 of the user device 100. FIGS. 2a and b show the user device 100 in an orientation in which its antennae 104 and 104 are oriented towards the respective antennae of the nodes (e.g. emitting and/or receiving radio signal(s) of a respective cell) of the cells 200, 300. In this orientation, the user device 100 may obtain an accurate estimate of maximum achievable signal strength and/or signal quality of the source cell 200 and/or the target cell 300. FIG. 2c shows a scenario in which the user device 100 is not ideally oriented. The antennae 104, 104 are not oriented towards the cells 200, 300. The measured signal quality and/or signal strength can be expected to be lower than the highest achievable signal strength and/or quality from either cell 200 and/or cell 300. In addition to the orientation, other influences may impact the measured signal strength and/or signal quality measured by the user device 100. FIG. 2d shows for instance an obstructed signal path between the antennae 104′ and the cell 300. Obstacles such as the shown hand are common and may attenuate the signal strength as received by the user device 100.

As a result of these different influences on the signal strength and/or quality measured or measurable by the user device 100 from a given cell 200, 300, the L1 measurements acquired by the user device 200 are less reliable than L3 measurements. If a handover of the user device 100 from the source DU 200 to the target DU 300 is based at least partially on such L1 measurements, the decision may be erroneous. It has been recognized that obstructions and/or misorientations of the user device 100 may cause the received signal strength and/or quality to be decreased but not increased, compared to an optimal orientation such as the one shown in FIG. 2a. If then the decision of a handover is at least partially based on the received signal strength and/or signal quality relating to the source cell 200, an erroneously low received signal strength and/or signal quality of the source cell may cause the user device 102 attempt a handover earlier than necessary. In other words, the connection strength and/or quality to the source DU 200 may actually still be sufficient to maintain a communication link 120 between the user device 100 and the source DU 200. In such cases, a fallback to the source DU 200 by the user device 100 may be feasible.

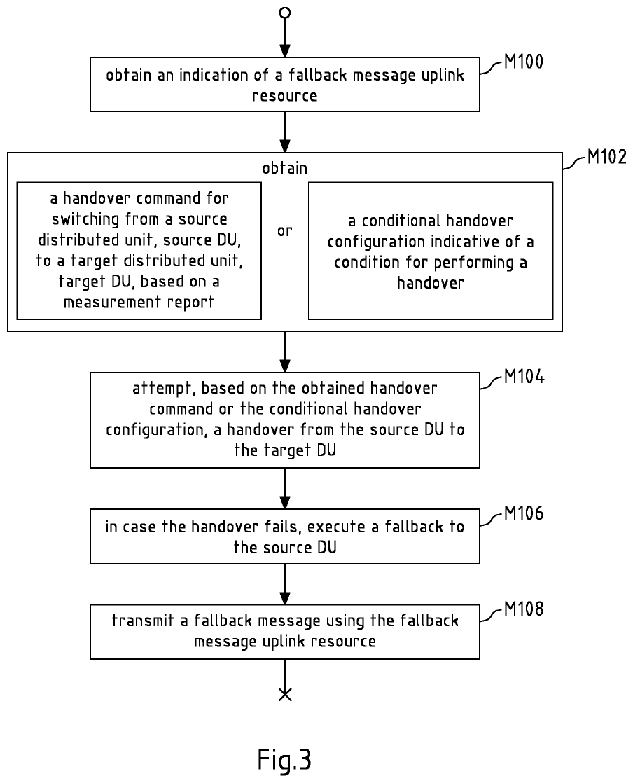

FIG. 3 shows a flow chart of a method according to the first exemplary aspect. The method shown may particular be performed by a user device 100 of FIG. 1.

In a first step M100 an indication of a fallback message uplink resource is obtained. For instance, a user device 100 may obtain such an indication from a source DU 200. The fallback message uplink resource may be suitable for transmitting a fallback message, in particular by the user device 100, in particular to the source DU 200 of FIG. 1.

The method further comprises step M102, in which a handover command for switching from a source DU 200 to a target DU 300 of FIG. 1 is obtained, based on a measurement report. Alternatively, a conditional handover configuration may be obtained, wherein the conditional handover configuration is indicative of a condition for performing a handover. The measurement report may in particular be indicative of and/or based on a measurement acquired by the user device 100. For instance, the user device 100 may acquire a measurement, transmit a measurement report to a source DU 200 and obtain a handover command from the source DU 200 based on the transmitted measurement report.

The steps M100 and M102 may be performed separately as shown in FIG. 3. Alternatively or additionally, the two steps may be performed together. In particular, the indication of a fallback message uplink resource may be obtained together with a handover command and/or with a conditional handover configuration.

The conditional handover configuration may be indicative of a condition for performing a handover, by the user device 100, from the source DU 200 to the target DU 300. When the user device 100 obtains a conditional handover configuration, the user device 100 may evaluate the condition as indicated by the conditional handover configuration and attempt handover if the condition is fulfilled, but not e.g. before the condition is fulfilled for the first time after receiving the indication. The condition may for instance relate to a measurement, particular a L1 measurement acquired by the user device 100.

Both the handover command and the conditional handover configuration may enable the user device 100 to implement a lower-level mobility, in which a handover is based on L1 measurements acquired by the user device 100. In both cases, the user device 100 may attempt a handover based on an L1 measurement.

The method shown in the flowchart of FIG. 3 further comprises attempting, in a step M104, based on the obtained handover command and/or the conditional handover configuration, a handover from the source DU to the target DU.

A handover to the target DU may fail. For instance, the user device 100 may be unable to establish a communication link 130 to target DU 300. In case the handover fails, the method may comprise the step of executing a fallback to the source DU 200, in particular by the user device 100.

The method may further comprise transmitting a fallback message using the fallback message uplink resource, step M108. A user device 100 performing the method of steps M100 through M108 is enabled to inform an entity within the communication network 1, in particular the source DU 200, about a fallback to the source DU 200 after a failed handover to the target DU 300. This is made possible by the fallback message uplink resource which has been obtained

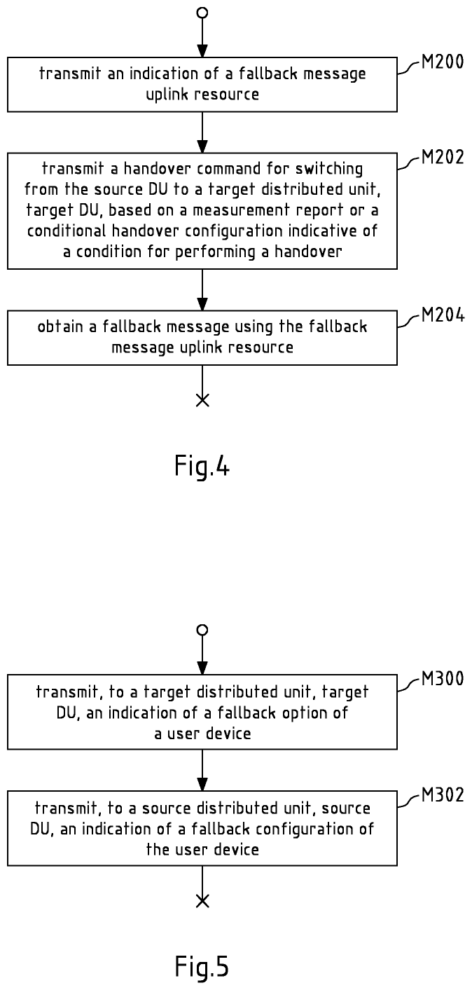

FIG. 4 shows a flowchart of a method according to the second exemplary aspect. The method may in particular be performed by a source DU 200 of FIG. 1.

In a first step M200, an indication of a fallback message uplink resource is transmitted. In particular, a source DU 200 may transmit an indication of a fallback message uplink resource to a user device 100 of FIG. 1. The step M200 may be performed in reaction to receiving a fallback configuration of a user device 100. In particular, the indication of a fallback message uplink resource may not be transmitted until a fallback configuration of a respective user device 100 has been obtained. For example, the source DU performing the method shown in FIG. 4 may have obtained an indication of a fallback configuration of a respective user device 100, in particular from a CU 400 of FIG. 1.

The method shown in FIG. 4 may further comprise transmitting a handover command for switching from a source DU 200 to a target DU 300 of FIG. 1 based on a measurement report (see step M202). The measurement report may for instance be obtained prior to transmitting the handover command. The measurement report may for instance have been obtained by a source DU 200 from a respective user device 100. For instance, the measurement report may relate to an L1 measurement acquired by the user device 100, in particular an L1 measurement relating to the source DU 200.

Additionally or alternatively to transmitting a handover command, the method may comprise transmitting a conditional handover configuration, wherein the conditional handover configuration is indicative of a condition for performing a handover. See description of FIG. 3 for more details.

The methods may further comprise step M204, i.e., obtaining a fallback message using the fallback message uplink resource. For instance, a respective source DU 200 performing the method shown in this flowchart of FIG. 4 may obtain the fallback message from a user device 100. The user device 100 may have transmitted the fallback message on the fallback message uplink resource to the source DU 200. In this way, the fallback message is received by the source DU 200 using the fallback message uplink resource.

FIG. 5 shows a flowchart of a method comprising the steps M300 and M302. The method shown may for instance be performed by a CU 400 of FIG. 1.

The method comprises step M300, wherein an indication of a fallback option of a user device is transmitted to a target distributed unit target DU 300 of FIG. 1. The target DU may be a distributed unit, to which a user device 100 of FIG. 1i s supposed to attend a handover, in particular a handover from a source DU 200 of FIG. 1. The indication of a fallback option informs the target DU 300 that a respective user device 100 will attempt a handover to the target DU 300 and that this user device 100 may fall back to a respective source DU 200 in case the handover fails.

The method further comprises transmitting, to a respective source distributed unit, source DU 200, an indication of a fallback configuration of the user device 100. The fallback configuration may inform the source DU 200 that the user device 100 is supposed to fall back to the source DU 200 in case and attempted handover to a target DU 300 fails. But transmitting the fallback configuration to the source DU 200, the CU 400 allows the source DU 200 prepare a fallback of the user device 100 to the source DU 200. For instance, the source DU 200 may determine a fallback message uplink resource on which the user device 100 may transmit a fallback message to the source DU 200 encased in the handover to the target DU 300 fails.

The order of steps shown in FIGS. 3 through 5 may represent the temporal succession of the respective steps. The steps may alternatively be performed in any permutation of the steps, where applicable.

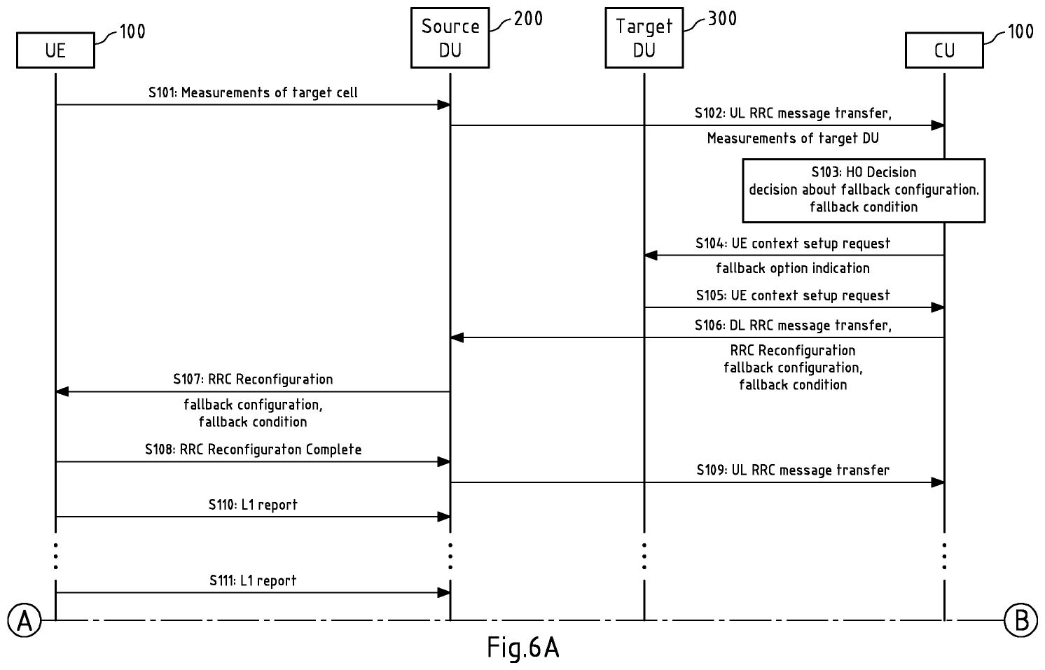

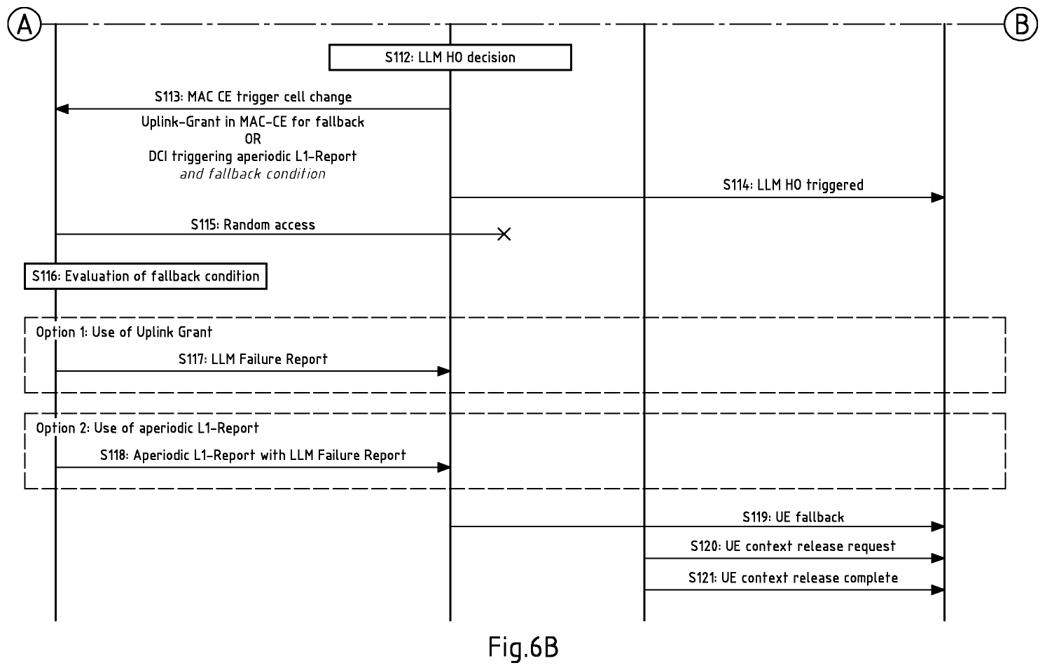

FIG. 6 shows a signaling diagram demonstrating an exemplary implementation of all exemplary aspects. Messages are exchanged between a user device 100, abbreviated with a UE (user equipment), a source DU 200, a target DU 380 and a CU 400. The UE 100, the source DU 200, the target DU 300 and the CU 400 may correspond to the entities user device 100, source DU 200, target DU 300 and CU 400 of FIG. 1.

The user device 100 may initially transmit measurements of a target cell 300 to a source DU 200 (see step S101). The measurement may particular be an L3, L2 and/or L1 measurement. The measurement may relate to the target DU 300. Alternatively and/or additionally, the measurement may as well relate to the source DU 200. The source DU may forward at least parts of the measurements of the target cell 300 to the central unit 400 (see step S102).

The CU 400 may decide on a handover in step S103. In the step, the CU 400 may determine (e.g. decide) and/or define a fallback configuration. Additionally or alternatively, the central unit 400 may define a fallback condition.

The CU 400 may transmit, in step S104, a user device context set up request to the target DU 300. The user device context setup request may particular comprise a fallback option indication directed to the target DU 300. The target DU 300 may respond to the user device context setup request by a user device context setup response to the CU 400 (see step S105).

The central unit 400 may in step S106 transmit a downlink radio resource control, DL RRC, message to the source DU 200. This message may indicate and/or comprise an radio resource control, RRC, re-configuration. Together with the DL RRC message, the CU 400 may transmit to the source DU 200, an indication of a fallback configuration. Optionally, the CU 400 may transmit an indication of a fallback condition to the source DU 200.

The source DU 200 may, after having obtained the DL RRC message in step S107, transmit an RRC re-configuration message to the user device 100,step S106. Together with the RRC re-configuration, the source DU 200 may transmit an indication of a fallback configuration to the user device 100. The fallback configuration may in particular correspond to the fallback configuration indicated by the indication the source DU 200 obtained from the central unit 400 in step S106. The RRC re-configuration sent from the source DU 200 to the user device 100 may comprise and/or be accompanied by an indication of a fallback condition. The fallback condition may particular correspond to the fallback condition indicated by the message obtained by the source DU 200 from the CU 400 in step S106. Alternatively, the source DU 200 may itself provide the fallback condition.

In a step S108, the user device 100 confirms the RRC re-configuration by transmitting and RRC re-configuration complete message to the source DU 200.

The source DU 200, in step S109, transmits a uplink RRC message to the CU 400.

After this initial set up, the user device 100 may send at least one measurement report to the source DU 200 in steps S110, S111. The measurement report may particular be indicative of at least one L1 measurement wherein the L1 measurement has in particular been acquired by the user device 100.

The measurement report may particular relate to the source DU 200. For example, the measurement report may be indicative of a signal strength and/or signal quality that can be received/observed by the user device 100 from the source DU 200, in particular on the L1 layer of the communication network 1.

For example, the user device 100 may continuously transmit one or more measurement reports to the source DU 200. Alternatively or additionally, the user device 100 may transmit one or more measurement reports to the source DU 200 periodically, for example in (e.g. essentially) regular intervals, for example periodically in intervals of duration or approximately (e.g., +/−5%, 10% or 20%) 1 ms, 2 ms, 10 ms, 20 ms, 40 m, 60 ms, 80 ms, 100 ms, 150 ms or 200 ms. The intervals may for instance be configurable and/or configured by the communication network, for instance by the source DU and/or by the CU. The user device 100 may also transmit measurement reports to the source DU 200 in aperiodic manner.

The source DU 200 may in a step S112 make a lower level mobility handover decision, LLM HO decision. The decision may in particular be based on at least one measurement report previously obtained from the user device 100 in steps S110, S111.

If the source DU 200 determines/decides that a handover is to be attempted by the user device 100, it may, in a step S113, transmit a handover command to the user device 100. The handover command may in particular be a medium access control control element, MAC CE, which may trigger a cell change. The handover command may comprise and/or be accompanied by a fallback message uplink resource. The fallback message uplink resource may for instance comprise an uplink grant, which may for instance be indicated in the MAC CE message. Alternatively or additionally, the fallback message uplink resource may comprise a downlink control information, DCI, triggering a periodic L1 report. In a step S113, the size DU 200 may transmit a fallback condition to the user device 100, in particular comprise by and/or accompanied by the MAC CE message. By transmitting the fallback condition together with the handover command, the fallback condition may be adapted to the current circumstances.

In a step S114, the source DU 200 may inform the CU 400 about the transmission of a handover command to the user device in a lower level mobility handover, LLM HO, triggered message transmitted from the source DU 200 to the central unit 400. This may be used for the initiation of a data forwarding to the target DU, for the activation of uplink resources from the target DU 300 for the user device in case of a RACHless handover, or other reasons.

In a step S115, the user device 100 attempts a random access to the target DU 300. RACH or RACHless handover may be attempted. The random access procedure may fail. As a result, the handover attempt from the source DU 200 to the target DU 300 by the user device 100 fails.

If a fallback condition has been obtained by the user device 100, for instance together with the handover command and/or in an RRC re-configuration, the fallback condition may be evaluated in a step S116, by the user device 100. In order to inform the source DU 200 about the fallback, the user device 100 may transmit a fallback message to the source DU 200 using the fallback message uplink resource.

The user device 100 may start evaluating the fallback condition after, in particular (e.g. essentially immediately) after, the failure is declared by the MAC layer. The user device 100 may alternatively start to evaluate the fallback condition at the moment the user device 100 attempts the handover, for example when it starts a RACH procedure to the target DU 300. The user device 100 may determine if the fallback condition is fulfilled at the time of a RACH failure.

Based on the evaluation of the fallback condition, the user device 100 may decide whether to execute a fallback to the source DU 200 or alternatively execute a recovery of any type (e.g., an RRC Re-establishment). For executing a fallback to the source DU 200, if the timing advance (TA) still applies (zero in case small of cells, same as target cell if co-located in same gNB, or old TA still applies (not outdated)) the user device 100 does not perform a Random Access. If the TA does not apply anymore (expired), the user device 100 may perform a CBRA or a CFRA if the user device 100 has been configured with CFRA resources for beam failure recovery (which may be re-used for fallback) or dedicated CFRA resources to be used in case of fallback, for instance.

As a first option, step S117, the user device 100 may use an uplink grant, which has been provided in a step S113, to transmit a fallback message to the source DU 200. Additionally or alternatively, a PUSCH location may be offset with respect to the PDSCH location containing the MAC command. This offset is preconfigured in the RRC Re-configuration message for fallback. The fallback message may be comprised by and/or accompanied with a failure report, in particular a lower level mobility, LLM, failure report. The LLM failure report may as well comprise the fallback message. The LLM failure report may as well be identical to the fallback message. In this case, for example, the user device 100 uses the fallback specific uplink scheduling grant as the fallback message uplink resource to provide the failure report, in particular to the source DU.

As a second option, the user device 100 and transmit the fallback message as in a periodic L1 report with an LLM failure report, see step S118. In this case, the DCI triggering a periodic L1 report obtained in a step S113 may be used by the user device 100 as a fallback message uplink resource. In this case, for example, the user device 100 may use the uplink scheduling grant for aperiodic L1-report to the source DU. In this message, the user device 100 includes and/or piggybacks the failure report (step 18).

In a step S119, the size DU 200 may inform the CU 400 about the fallback of the user device. The CU 400 may in reaction to being informed about the fallback, transmit a user device context release request in a step S120 two the target DU 300. In a step S121, the target DU 300 may answer with a user device context release complete message. For instance, the target DU 300 may in this way be enabled to release a target configuration, which for example may comprise at least one radio resource reserved for the communication link 130 between the user device 100 and the target DU 300. Upon the reception of the failure report from the user device, the source DU 200 informs the CU 400 about the fallback process of the user device 100. In this message it may contain report information such as for instance a failure cause, a timing information, etc.

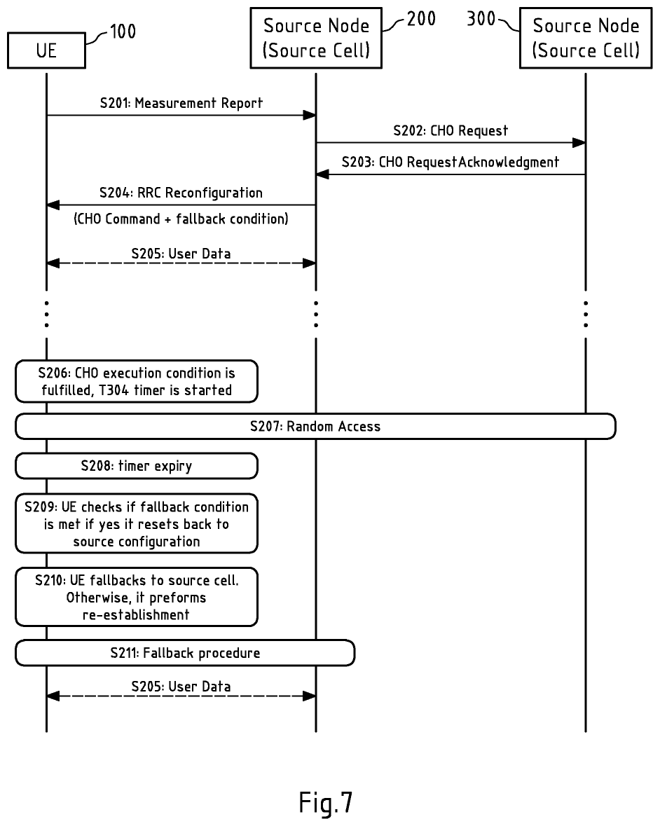

FIG. 7 shows another exemplary signaling diagram showing an example implementation of all exemplary aspects. The process shown in FIG. 7 corresponds to a conditional handover, CHO, or baseline handover, baseline HO, procedure. The user device 100, source DU 200 and target DU 300 shown in FIG. 7 may be represented by a respective user device 100 of FIG. 1, a respective source DU 200 in FIG. 1, a respective target DU 300 in FIG. 1. In this case the user device 100 will execute a fallback to the source node 200 by evaluating a local condition in order to avoid a CHO recovery and RRC re-establishment. FIG. 7 shows the case for CHO, but the same process could be applied for a Baseline HO. Messages are exchanged between the user device 100, the source notes 200 and the target node 300. The source node 200 and/or the target node 300 may for instance be distributed units, and DU. They may be the different kinds of network notes within a communication network 1.

In a step S201, a measurement report is transmitted by the user device 100 obtained by the source node 200. The source node 200 then transmits, in a step S202, a conditional handover, CHO, request to the target node 300. The target node 300, after having received the CHO request from the source notes 200, transmits a CHO request acknowledgment in a step S203. Steps S201 to S203 are described for a conditional handover e.g. in Rel.16 TS38.300 of the 3GPP standard.

In step S204, the source node 200 transmits a RRC re-configuration message which is received by the user device 100. The RRC re-configuration message comprises and/or is accompanied by a conditional handover command, CHO command. The RRC re-configuration message further comprises and/or is accompanied by a fallback condition. The fallback condition indicates a condition, on which the handover of the user device 100 from the source node 200 to the target node 300 is conditional.

After transmitting the RRC re-configuration from the source node 200 to the user device 100, the user device 100 and the source node 200 may stay in contact, see step S205. The communication link 120 between the user device 100 and source node 200 may in particular still be active. User data may still be exchanged between the user device 100 and source node 200.

In a step S206, the fallback condition obtained by the user device 100 in a step S204 is fulfilled. As a result, the user device 100 attempts a handover from the source node 200 to the target node 300. In the shown embodiment, a timer may be started, in particular by a timer T304.

The user device 100 subsequently attempts the handover, in particular the random-access to the target node 300 in a step S207.

If the random-access to the target node 300 does not succeed before the timer ends in a step S208, the handover of the user device 100 from the source node 200 to the target node 300 has failed.

If the user device 100 has obtained a fallback condition in a step S204, the user device 100 may evaluate if the fallback condition is fulfilled in a step S209. If the fallback condition is indeed fulfilled, the user device 100 may execute a fallback to the source node 200 in a step S210. In particular, the user device 100 may revert back to a source configuration. The source configuration may in particular indicate at least one radio resource used for the communication link 120 between the user device 100 and the source node 200. If the fallback condition is not fulfilled, the user device 100 may perform an RRC reestablishment.

The fallback procedure in step S211 may comprise, if timing advance (TA) still applies (zero in case small of cells, same as target cell if co-located in same gNB, or old TA still applies (not outdated)), the user device may send a MAC CE or an RRC message (RRC fallback message) to the source node 200 as indication for falling back. If TA does not apply anymore (expired), the user device 100 may perform a contention based random access, CBRA, or contention free random access, CFRA, if the user device 100 has been configured with CFRA resources for beam failure recovery (e.g. to be re-used for fallback) or dedicated CFRA resources to be used in case of fallback, for instance. The fallback may be considered to be completed when the random access is completed. The user device 100 may indicate using MAC CE or RRC message (RRC fallback message) that this random access is part of the fallback to source cell 200.

Within the procedure shown in FIG. 7, the fallback condition may be provided to the user device 100 using the CHO command obtained by the user device 100 in the step S204. The fallback condition may be transmitted by the source node 200 as an additional parameter in the CHO command.

Additionally or alternatively, the source node 200 may transmits an indication of the fallback condition to the target node 300. For instance, this may be done in the CHO request transmitted in step S202. The target node 300 may include an indication of the fallback condition in the RRC configuration which the target node 300 transmits to the source node 200 by the CHO request acknowledgment. The user device 100 may then obtain the fallback condition when decoding the RRC configuration as obtained from the source cell 200 and/or from the target cell 300 via the source cell 200.

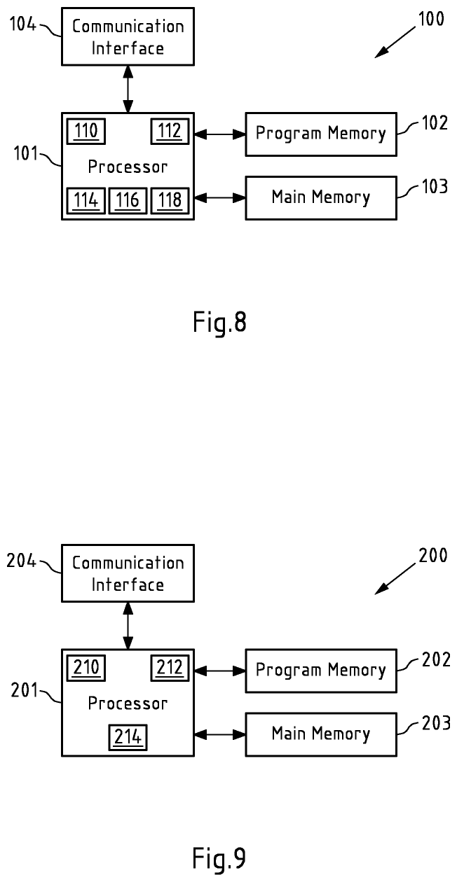

FIG. 8 shows a schematic of a user device 100 (e.g. user device 100 of FIG. 1) according to the first exemplary aspect. The user device comprises a communication interface 104. The communication interface 104 may particular comprise at least one antenna. The user device 100 further comprises a main memory 103 as well as a program memory 102. The instructions of the first exemplary aspect may be stored on the main memory 103 and/or the program memory 102. In the user device 100 may further comprise a processor 101.

The user device 100 may in particular comprise a first obtaining unit 110, which is configured to obtain an indication of a fallback message uplink resource. The user device 100 may further comprise a second obtaining unit 112 configured for obtaining a handover command and/or a conditional handover configuration. The user device 100 may further comprise an attempter 114, wherein the attempter 114 is configured to attempt a handover from a source DU 200 to a target DU 300 based on the obtained handover command or the conditional handover configuration. The user device 100 may further comprise a fallback executor 116, wherein the fallback executor 116 is configured to execute a fallback of the user device 100 if the attempted handover fails. The user device 100 may further comprise a transmitter 118 which may be configured to transmit a fallback message using the fallback message uplink resource. The first obtaining unit 110, the second obtaining unit 112, the attempter 114, the fallback executer 116 and/or the transmitter 118 may in particular correspond to a functional and/or structural unit of the processor 101.

FIG. 9 shows a schematic of a source DU 200 (e.g. DU 200 or 300 of FIG. 1) according to the second exemplary aspect. The source DU comprises a communication interface 204. The communication interface 204 may in particular comprise at least one antenna. The source DU 200 further comprises a main memory 203 as well as a program memory 202. The instructions of the second exemplary aspect may be stored on the main memory 203 and/or the program memory 202. The source DU 200 may further comprise a processor 201.

The source DU 200 may comprise a first transmitter 210. The transmitter 210 may be configured to transmit an indication of a fallback message uplink resource, in particular to a user device 100. The source DU 200 may further comprise a second transmitter 212 which may be configured to transmit a handover command and/or a conditional handover configuration, in particular to a user device 100. The source DU 200 may further comprise an obtainer 214, which may be configured to obtain a fallback message using the fallback message uplink resource. The first transmitter 210, the second transmitter 212 and/or the obtainer 214 may in particular correspond to a functional and/or structural unit of the processor 201.

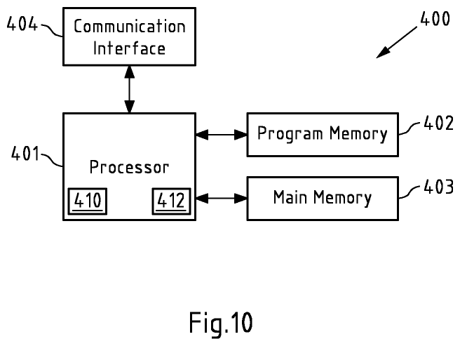

FIG. 10 shows a schematic of a CU 400 (e.g. CU 400 of FIG. 1) according to the third exemplary aspect. The CU 400 comprises a communication interface 404. The communication interface 404 may in particular comprise at least one antenna. The CU 400 further comprises a main memory 403 as well as a program memory 102. The instructions of the third exemplary aspect may be stored on the main memory 403 and/or the program memory 402. The CU 400 may further comprise a processor 401.

The CU may comprise a first transmitter 410, which may be configured to transmit an indication of a fallback option of a user device 100, in particular to a target DU 300. The CU may further comprise a second transmitter 412 which may be configured to transmit an indication of a fallback configuration of the user device 100, in particular to a source DU 200. The first transmitter 410 and/or the second transmitter 412 may in particular correspond to a functional and/or structural unit of the processor 401.

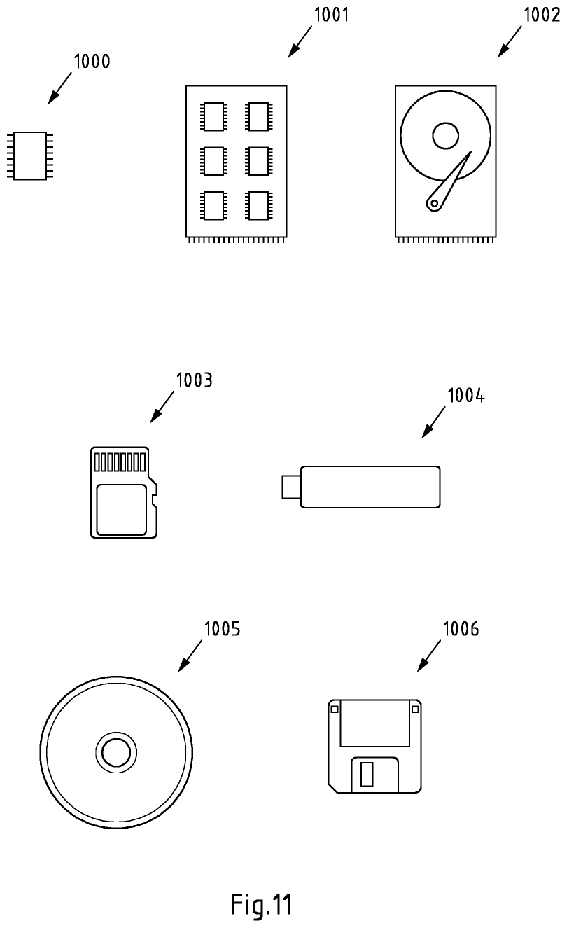

FIG. 11 is a schematic illustration of examples of tangible and non-transitory computer-readable storage media according to the present invention that may for instance be used to implement program and/or main memory 102, 103, 202, 203, 402, 403 of the apparatuses 100, 200, 300 and/or 400 of FIGS. 8, 9, and 10. FIG. 10 shows a flash memory 1000, which may for instance be soldered or bonded to a printed circuit board, a solid-state drive 1001 comprising a plurality of memory chips (e.g.

Flash memory chips), a magnetic hard drive 1002, a Secure Digital (SD) card 1003, a Universal Serial Bus (USB) memory stick 1004, an optical storage medium 1005 (such as for instance a CD-ROM or DVD) and a magnetic storage medium 1006.

Furthermore, at least the following embodiments should be considered to be specifically disclosed:

### Embodiment 1:

A method, e.g. performed by a user device, comprising:
obtain, an indication of a fallback message uplink resource;
obtain a handover command for switching from a source distributed unit, source DU, to a target distributed unit, target DU, based on a measurement report or a conditional handover configuration indicative of a condition for performing a handover;
attempt, based on the obtained handover command or the conditional handover configuration, a handover from the source DU to the target DU; and
in case the handover fails, execute a fallback to the source DU; and
transmit a fallback message using the fallback message uplink resource.

### Embodiment 2:

The method according to Embodiment 1, wherein:
the handover fails because the user device fails to apply a new configuration to the target DU and/or
the handover fails because the user device fails to execute a random access to the target DU, in particular a random access channel, RACH, access of the user device fails.

Embodiment 3:

The method according to Embodiment 1 or 2, wherein:
fallback message uplink resource is pre-configured and the indication of the fallback message uplink resource is obtained
via radio resource control, RRC, re-configuration and/or
as a part of the handover command and/or the conditional handover configuration.

### Embodiment 4:

The method according to Embodiment 1 or 3, wherein:
the fallback message uplink resource is a next uplink resource available, wherein the next uplink resource available is configured as a periodic uplink resource allocation.

Embodiment 5:

The method according to any of Embodiments 1 to 4, further comprising:
inform a central unit, CU, about the fallback of the user device to the source DU.

### Embodiment 6:

The method according to any of Embodiments 1 to 5, further comprising:
obtain an indication of a fallback condition, wherein the fallback condition needs to be fulfilled for executing the fallback of the user device to the source DU.

### Embodiment 7:

The method according to Embodiment 6, wherein:
the indication of the fallback condition is obtained together with the indication of the fallback message uplink resource; and/or
the fallback condition is set by the CU; and/or
the fallback condition is at least partly based on a target DU measurement.

Embodiment 8:

The method according to Embodiment 6 or 7, wherein:
a minimum signal strength and/or signal quality of the source DU; and/or
a comparison of the signal strength and/or signal quality of the source DU to one or more potential target DUs; and/or
a comparison of the signal strength and/or signal quality of the source DU to neighboring DUs.

Embodiment 9:

A method, e.g. performed by a source distributed unit, source DU, comprising:
transmit an indication of a fallback message uplink resource,
transmit a handover command for switching from the source DU to a target distributed unit, target DU, based on a measurement report or a conditional handover configuration indicative of a condition for performing a handover; and
obtain a fallback message, using the fallback message uplink resource.

Embodiment 10:

The method according to Embodiment 9, further comprising:
obtain, from a central unit, CU, an indication of a fallback configuration of the user device.

Embodiment 11:

The method according to Embodiment 10, further comprising:
obtain, from the CU, an indication of a fallback condition.

### Embodiment 12:

The method according to any of Embodiments 9 to 11, further comprising:
transmit an indication of a fallback condition.

### Embodiment 13:

The method according to any of Embodiments 10 to 12, further comprising:
transmit, to the CU, at least a part of the fallback message obtained from the user device; and/or
transmit, to the CU, an indication of a fallback of the user device.

### Embodiment 14:

The method according to any of Embodiments 9 to 13, further comprising: prevent a release of a source configuration of the user device after transmitting the handover command and/or the conditional handover configuration to the user device.

Embodiment 15:

The method according to any of Embodiments 9 to 14, further comprising:
determine the fallback message uplink resources before transmitting the indication of the fallback message uplink resources.

### Embodiment 16:

A method, e.g. performed by a central unit, comprising:
transmit, to a target distributed unit, target DU, an indication of a fallback option of a user device; and
transmit, to a source distributed unit, source DU, an indication of a fallback configuration of the user device.

### Embodiment 17:

The method according to embodiment 16, wherein:
the indication of a fallback option is accompanied by an indication of a fallback condition.

Embodiment 18:

The method according to embodiment 16 or 17, further comprising:
set the fallback configuration based, at least in part, on at least one measurement relating to the target DU.

### Embodiment 19:

The method according to any of embodiments 16 to 18, further comprising:
obtain an indication of a performed fallback of the user device to the source DU at least partially based on a fallback message uplink resource; and
transmit a context release request for the user device to the target DU upon the obtaining.

### Embodiment 20:

A method, e.g. performed by a user device and a source DU, comprising:
transmit, by the source DU, an indication of a fallback message uplink resource,
obtain, by the user device, an indication of a fallback message uplink resource;
transmit, by the user device, a handover command for switching from the source DU to a target distributed unit, target DU, based on a measurement report or a conditional handover configuration indicative of a condition for performing a handover;
obtain, by the user device, a handover command for switching from a source distributed unit, source DU, to a target distributed unit, target DU, based on a measurement report or a conditional handover configuration indicative of a condition for performing a handover;
attempt, by the user device,, based on the obtained handover command or the conditional handover configuration, a handover from the source DU to the target DU; and
in case the handover fails, execute, by the user device, a fallback to the source DU; and
transmit, by the user device, a fallback message using the fallback message uplink resource.

### Embodiment 21:

The method according to Embodiment 20, wherein:
the handover fails because the user device fails to apply a new configuration to the target DU and/or
the handover fails because the user device fails to execute a random access to the target DU, in particular a random access channel, RACH, access of the user device fails.

### Embodiment 22:

The method according to Embodiment 20 or 21, wherein:
the fallback message uplink resource is pre-configured and the indication of the fallback message uplink resource is obtained, by the user device,
   via radio resource control, RRC, re-configuration and/or
   as a part of the handover command and/or the conditional handover configuration.

### Embodiment 23:

The method according to any of Embodiments 20 to 22, wherein:
the fallback message uplink resource is a next uplink resource available, wherein the next uplink resource available is configured as a periodic uplink resource allocation.

### Embodiment 24:

The method according to any of Embodiments 20 to 23, further comprising:
inform, by the user device, a central unit, CU, about the fallback of the user device to the source DU.

### Embodiment 25:

The method according to any of Embodiments 20 to 24, further comprising:
obtain, by the user device, an indication of a fallback condition, wherein the fallback condition needs to be fulfilled for executing the fallback of the user device to the source DU.

Embodiment 26:

The method according to Embodiment 25, wherein:
the indication of the fallback condition is obtained, by the user device, together with the indication of the fallback message uplink resource; and/or
the fallback condition is set by the CU; and/or
the fallback condition is at least partly based on a target DU measurement.

### Embodiment 26:

The method according to Embodiment 25 or 26, wherein:
a minimum signal strength and/or signal quality of the source DU; and/or
a comparison of the signal strength and/or signal quality of the source DU to one or more potential target DUs; and/or
a comparison of the signal strength and/or signal quality of the source DU to neighboring DUs.

Embodiment 28:

The method according to any of the Embodiments 20 to 27, further comprising:
obtain, by the source DU, from a central unit, CU, an indication of a fallback configuration of the user device.

Embodiment 29:

The method according to any of the Embodiments 20 to 28, further comprising:
obtain, by the source DU, from the CU, an indication of a fallback condition.

Embodiment 30:

The method according to any of the Embodiments 20 to 29, further comprising:
transmit, by the source DU, an indication of a fallback condition.

Embodiment 31:

The method according to any of the Embodiments 20 to 30, further comprising:
transmit, by the source DU, to the CU, at least a part of the fallback message obtained from the user device; and/or
transmit, by the source DU, to the CU, an indication of a fallback of the user device.

Embodiment 32:

The method according to any of the Embodiments 20 to 31, further comprising:
prevent, by the source DU, a release of a source configuration of the user device after transmitting the handover command and/or the conditional handover configuration to the user device.

Embodiment 33:

The method according to any of the Embodiments 20 to 32, further comprising:
determine, by the source DU, the fallback message uplink resources before transmitting the indication of the fallback message uplink resources.

### Embodiment 34:

The method according to any of the Embodiments 20 to 33, e.g. further performed by a CU, further comprising:
transmit, by the CU, to the source distributed unit, source DU, an indication of a fallback configuration of the user device or
transmit, by the CU, to the target distributed unit, target DU, an indication of a fallback option of the user device.

Embodiment 35:

The method according to any of the Embodiments 20 to 34, wherein:
the indication of a fallback option, transmitted by the CU, is accompanied by an indication of a fallback condition.

### Embodiment 36:

The method according to any of the Embodiments 20 to 35, further comprising:
set, by the CU, the fallback configuration based, at least in part, on at least one measurement relating to the target DU.

### Embodiment 37:

The method according to any of the Embodiments 20 to 36, further comprising:
obtain, by the CU, an indication of a performed fallback of the user device to the source DU at least partially based on a fallback message uplink resource; and
transmit, by the CU, a context release request for the user device to the target DU upon the obtaining.

### Embodiment 38:

A first apparatus comprising respective means for performing the method of any of embodiments 1 to 8.

Embodiment 39:

A first apparatus comprising at least one processor and at least one memory storing instructions that, when executed by the at least one processor, cause an apparatus at least to perform and/or control the method according any of embodiments 1 to 8.

### Embodiment 40:

A second apparatus comprising respective means for performing the method of any of embodiments 9 to 15.

### Embodiment 41:

A second apparatus comprising at least one processor and at least one memory storing instructions that, when executed by the at least one processor, cause an apparatus at least to perform and/or control the method according any of embodiments 9 to 15.

### Embodiment 42:

A third apparatus comprising respective means for performing the method of any of embodiments 16 to 19.

Embodiment 43:

A third apparatus comprising at least one processor and at least one memory storing instructions that, when executed by the at least one processor, cause an apparatus at least to perform and/or control the method according any of embodiments 16 to 19.

### Embodiment 44:

A fourth apparatus comprising respective means for performing the method of any of embodiments 20 to 37.

### Embodiment 45:

A fourth apparatus comprising at least one processor and at least one memory storing instructions that, when executed by the at least one processor, cause an apparatus at least to perform and/or control the method according any of embodiments 20 to 37.

Embodiment 46:

A computer program, the computer program when executed by a processor causing an apparatus, e.g. the apparatus according to any of embodiments 38 to 45, to perform and/or control the actions and/or steps of the method of any of embodiments 1 to 38.

Embodiment 47:

A computer program product comprising a computer program according to embodiment 46.

### Embodiment 48:

A system comprising:
at least one first apparatus according to any of the embodiments 38 to 39;
at least one second apparatus according to any of the embodiments 40 to 41;
at least one third apparatus according to any of the embodiments 42 to 43; and/or
at least one fourth apparatus according to any of the embodiments 44 to 45.

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Having the same meaning as the expression “A and/or B”, the expression “at least one of A or B” may be used herein. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A.

It will be understood that all presented embodiments are only exemplary, and that any feature presented for a particular example embodiment may be used with any aspect on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program/system) may also be used in a corresponding manner in an example embodiment of any other category. It should also be understood that presence of a feature in the presented example embodiments shall not necessarily mean that this feature forms an essential feature and cannot be omitted or substituted.

The statement of a feature comprises at least one of the subsequently enumerated features is not mandatory in the way that the feature comprises all subsequently enumerated features, or at least one feature of the plurality of the subsequently enumerated features. Also, a selection of the enumerated features in any combination or a selection of only one of the enumerated features is possible. The specific combination of all subsequently enumerated features may as well be considered. Also, a plurality of only one of the enumerated features may be possible.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure.

The subject-matter has been described above by means of example embodiments. It should be noted that there are alternative ways and variations which are obvious to a skilled person in the art and can be implemented without deviating from the scope of the appended claims.

1-26. (canceled)

27. A user device comprising:
at least one processor; and
at least one memory storing instructions that, when executed by the at least one processor, cause the user device at least to perform:
obtain, an indication of a fallback message uplink resource;
obtain a handover command for switching from a source node supporting a source distributed unit, source DU, to a target node supporting a target distributed unit, target DU, based on a measurement report or a conditional handover configuration indicative of a condition for performing a handover;
attempt, based on the obtained handover command or the conditional handover configuration, a handover from the source node to the target node; and
in case the handover fails, execute a fallback to the source node; and
transmit a fallback message using the fallback message uplink resource.

28. The user device according to claim 27, wherein
the handover fails because the user device fails to apply a new configuration to the target node and/or
the handover fails because the user device fails to execute a random access to the target node, in particular a random access channel, RACH, access of the user device fails.

29. The user device according to claim 27, wherein
the fallback message uplink resource is pre-configured and the indication of the fallback message uplink resource is obtained
via radio resource control, RRC, re-configuration and/or
as a part of the handover command and/or the conditional handover configuration.

30. The user device according to claim 27, wherein
the fallback message uplink resource is a next uplink resource available, wherein the next uplink resource available is configured as a periodic uplink resource allocation.

31. The user device according to claim 27, the at least one memory further storing instructions that, when executed by the at least one processor, cause the user device at least to perform:
inform a network node supporting a central unit, CU, about the fallback of the user device to the source node.

32. The user device according to claim 27, the at least one memory further storing instructions that, when executed by the at least one processor, cause the user device at least to perform:
obtain an indication of a fallback condition, wherein the fallback condition needs to be fulfilled for executing the fallback of the user device to the source node.

33. The user device according to claim 32, wherein
the indication of the fallback condition is obtained together with the indication of the fallback message uplink resource; and/or
the fallback condition is set by the network node; and/or
the fallback condition is at least partly based on a target node measurement.

34. The user device according to claim 32, wherein the fallback condition comprises
a minimum signal strength and/or signal quality of the source node; and/or
a comparison of the signal strength and/or signal quality of the source node to one or more potential target nodes; and/or
a comparison of the signal strength and/or signal quality of the source node to neighboring nodes.

35. A source node supporting a source distributed unit, source DU, comprising:
at least one processor; and
at least one memory storing instructions that, when executed by the at least one processor, cause the source node at least to perform:
transmit an indication of a fallback message uplink resource, transmit a handover command for switching from the source node to a target distributed unit, target node, based on a measurement report or a conditional handover configuration indicative of a condition for performing a handover; and
obtain a fallback message, using the fallback message uplink resource.

36. The source node according to claim 35, the at least one memory further storing instructions that, when executed by the at least one processor, cause the source DU at least to perform:
obtain, from a network node supporting a central unit, CU, an indication of a fallback configuration of the user device.

37. The source node according to claim 36, the at least one memory further storing instructions that, when executed by the at least one processor, cause the source DU at least to perform:
obtain, from the CU, an indication of a fallback condition.

38. The source node according to claim 35, the at least one memory further storing instructions that, when executed by the at least one processor, cause the source DU at least to perform:
transmit an indication of a fallback condition.

39. The source node according to claim 36, the at least one memory further storing instructions that, when executed by the at least one processor, cause the source node at least to perform:
transmit, to the network node, at least a part of the fallback message obtained from the user device; and/or
transmit, to the network node, an indication of a fallback of the user device.

40. The source node according to claim 35, the at least one memory further storing instructions that, when executed by the at least one processor, cause the source node at least to perform:
prevent a release of a source configuration of the user device after transmitting the handover command and/or the conditional handover configuration to the user device.

41. The source node according to claim 35, the at least one memory further storing instructions that, when executed by the at least one processor, cause the source node at least to perform:
determine the fallback message uplink resources before transmitting the indication of the fallback message uplink resources.

42. A network node supporting a central unit, CU, comprising:
at least one processor; and
at least one memory storing instructions that, when executed by the at least one processor, cause the network node at least to perform:
transmit, to a target node supporting a target distributed unit, target DU, an indication of a fallback option of a user device; and
transmit, to a source node supporting a source distributed unit, source DU, an indication of a fallback configuration of the user device.

43. The network node according to claim 42, wherein
the indication of a fallback option is accompanied by an indication of a fallback condition.

44. The network node according to claim 42, the at least one memory further storing instructions that, when executed by the at least one processor, cause the CU at least to perform:
set the fallback configuration based, at least in part, on at least one measurement relating to the target DU.

45. The network node according to claim 42, the at least one memory further storing instructions that, when executed by the at least one processor, cause the network node at least to perform:
obtain an indication of a performed fallback of the user device to the source node at least partially based on a fallback message uplink resource; and
transmit a context release request for the user device to the target node upon the obtaining.

46. A method comprising:
obtain, an indication of a fallback message uplink resource;
obtain a handover command for switching from a source distributed unit, source DU, to a target distributed unit, target DU, based on a measurement report or a conditional handover configuration indicative of a condition for performing a handover;
attempt, based on the obtained handover command or the conditional handover configuration, a handover from the source DU to the target DU; and
in case the handover fails, execute a fallback to the source DU; and
transmit a fallback message using the fallback message uplink resource.
